(19) United States
(12) Patent Application Publication
(10) Pub. No.: US 2015/0341306 A1
(43) Pub. Date: Nov. 26, 2015

(54) DATING STATUS INDICIA AND METHOD OF CONFIDENTIALLY MAKING CONTACT

(71) Applicant: Kristy Ostrander, Macomb, MI (US)

(72) Inventor: Kristy Ostrander, Macomb, MI (US)

(21) Appl. No.: 14/720,329

(22) Filed: May 22, 2015

Related U.S. Application Data
(60) Provisional application No. 62/002,040, filed on May 22, 2014.

(51) Int. Cl. H04L 12/58

(52) U.S. Cl. CPC H04L 51/32; H04L 51/04

(57) ABSTRACT

A new device, method of using same and a method of doing business for helping single people to connect with one another, especially through second chance connections, without the use of profile matching, unless otherwise desired. The devices are to include some indicia of the person's single status, such that another person that observes the indicia, and wishing to meet the first person will be able to leave a message on a SEEKING website message board or any other message spot they may designate, in order that the first person can pick up the message. The message can be left any place that the SEEKING member will designate as their preferred place to receive messages. The method of using the SEEKING message board includes both proactive and reactive participation, and the method of doing business discloses a possible franchising opportunity.

### BACKGROUND OF THE INVENTION

1. Field of the Invention

The present invention relates to a device and method for connecting people, and methods of using same. More particularly, the invention relates to a dating status indicia, methods of using the indicia to make a connection, and methods of using the Internet to make contact.

2. Description of the Prior Art

Conventional dating methods are well known in the art, including one of the most modern common types of online dating site postings, which usually include a very detailed personal profile, such as Match.com, ChristianMingle.com or eHarmony.com. Each of these prior art Internet sites require posting of a fair amount of personal information in a profile. These sites then match up potential suitors with another person based on their profile.

However, practitioners of those inventions have become aware of certain problems which are presented by those prior art inventions. One particular problem that has plagued users has been that the users don't want to put out all that personal information without knowing who has access to their information, or without the user having control over who has access to all that personal information. Another drawback to online dating is that it limits the potential connection simply because their profiles do not match. This is somewhat of an issue just like lack of privacy, that my invention solves.

Actually, flirting is a fine art, and is best practiced in second chance meetings. The anticipation of meeting someone is always a bit exhilarating, and both parties would benefit from a heightened sense of desire over a longer period of time than just meeting someone immediately and providing them with your contact information. This sense of anticipation cannot be overestimated, and may further increase a sense of yearning that is a direct result of flirting. With the hustle and bustle of everyday life, one of life's greatest pleasures has always been falling in love. As all the classic romance novels will confirm, anticipation of falling in love and selecting someone to fall in love with is one of life's exhilarating activities. Providing too much information in the beginning can ruin the chances for a solid relationship to blossom. Preconceived notions can quench that fire of desire based upon facts that may not actually be very relevant to a new relationship. Who doesn't remember the first date that you had with your spouse, in which it seemed that you never had so much in common as you did on your first date? Learning too much too soon about another person can sometimes create a problem without giving the relationship a chance.

Therefore, it would be desirable to the matchmaking or dating contact industry if there was provided a secure way to connect with a person that sees you in a public location, and method of making it known that you are single and looking, and determining whether or not you wish your personal information to be given to them. We call this a “second chance meeting”. This is a modern take on the old method of meeting potential partners. Our grandfathers might have seen a pretty girl in church or perhaps in a shop, and he would make inquiries about her. There would not have been any direct contact, so he would arrange to have a second chance meeting. My invention will do the same thing, except nowadays, shopkeepers and local nosy busy bodies are not around like those days of yore. My invention replaces the matchmakers, while still providing a discreet manner for achieving that “second chance” meeting.

Some people want to take their dating connections back to the “good old days” whereby you might meet someone by fate and it would help to take the guesswork out of whether or not they are single. If, for whatever reason, you are unable to exchange contact information, the dating industry would like to have a way to reconnect, a common website without needing a profile, or needing to sign up for anything. The industry is looking for a very easy, reactive way to meet someone.

Although there are prior art proactive indicia type bracelets, they merely indicate that a person is single and looking. There is no “second chance” in their method. In the description of those types of such prior art bracelets, one would be letting another person know, before even talking, that you are single. This would necessitate the initiation of an actual face-to-face contact, known as the “first chance meeting”. Otherwise, once the person got out of your sight, you'd never be able to re-connect. This makes some people very uncomfortable, and they might want to wait for a better time in order to contact the person of their desires that they just saw.

This is why a second chance meeting is more desirable for many people. In fact, there are many indications of people wanting a second chance to re-connect after a missed connection. For people who think that they could have met “The one”, but no contact information was exchanged, there are very limited means for achieving the second chance meeting. One way is that there is a section in newspapers and another way is on Craigslist for missed connections, along with other websites just for missed connections. However, there is no way of knowing where to put in an ad so that the other person will look there to seek you out.

Consequently, it would be most desirable to have devices and methods to let someone know where they can find you if they wanted a second chance to talk to you.

### SUMMARY OF THE INVENTION

In accordance with the present invention, devices, methods and methods of doing business are disclosed for connecting people that are single and wishing to meet someone. In practicing these methods, these single people may want to wear one of the devices of the present invention, indicating their single status. Singles may especially want to wear one of our devices, including some sort of “SEEKING” indicia, when they are going somewhere that may have potential to meet someone that they are attracted to. The following descriptions will detail the devices, methods of use and methods of doing business embodied in this invention.

In its most basic form, a person seeking to meet new people would wear one of my visible indicia out in public. If someone noticed the indicia and wanted to meet the person wearing the indicia, they might wave at each other and then they would go to our website and post a note for the indicia-wearing person, stating something like “I was the guy in the green jogging outfit that caught your attention and I'll like to go for a coffee. You were the girl wearing the pink jacket and the blue baseball cap that was running in Memorial Park on June 12 at sunset. Can we chat?” Since the girl would have known that she was wearing her bracelet, she would be inclined to check the website and check for the messages. She would find his message and decide whether or not she wanted to respond. If she saw him waving at her and she liked what she saw, she could make a determination about whether or not she wanted to respond. If she didn't know what he looked like, she might decide to respond without any personal information so that she could back out if she did not find him attractive.

In that regard, the present invention provides various aspects, including wearing on one's person such a wearable dating status indicia, like a bracelet, necklace, earrings, ring, ribbon, headband, hat or other easily visible indicia, as well as a method of making contact with the person that is wearing the indicia. In certain aspects of my invention, a second chance type of contact can be achieved by the observer person going online and entering the zip code, or other location, where the person wearing the indicia was seen. Then both parties can decide, after speaking to one another, whether or not personal information should be shared. This overcomes most of the aforementioned problems with the prior art because if the person is not to one's liking, then you simply do not share any more personal information, such as a phone number or email address. The present invention is a dating system and method which prevents the personal information exposure to someone trying to make contact to a person that they may have seen out in public. Since dating methods are highly personal and constantly evolving, especially in the social media and internet age, methods need to adapt to provide a confidential service to single individuals.

A single person wishing to make connections with other single people can wear a dating status indicia, such as wearable jewelry, ribbons, headbands, hats or the like providing an indication that they are single and a member of the SEEKING program. For example, if you are walking in a park, and wearing a SEEKING indicia, and another person sees you and is attracted to you, they would go onto a SEEKING website, enter the zip code, or other location determining situation, in which they saw you and make contact by identifying themselves. In this example, the walker may be a female wearing a bracelet or a hat, and the male may wave at her and then carry on walking without making any kind of connection. The “second chance” connection that becomes possible through the SEEKING system is that both participants will go to the SEEKING website, and click in the zip code where they were located, and identify themselves, such as “I'm the gentleman who had on the white hat that waved to you in the park”, etc. The female walker may be interested in meeting with him and can send him back a message. They can then trade personal information after they have had a chance to speak and determine that it is worth going forward.

This in is direct contradistinction to previous and prior art dating methods in which all your personal information is posted on a website and potential suitors will select you from a list of people that they may find interesting. Prior art methods, including a method disclosed in U.S. Pat. No. 7,255,277 which requires posting a profile, provided too much information for the comfort of some.

In employing this method, any type of wearable indicia will be acceptable, as long as people can see the coded portion of the item, i.e., the SEEKING logo. The indicia may include bracelets, rings, necklaces, buttons, t-shirts, hats or any other type of coded item that is visible when one is out in the public.

A first aspect of the present invention includes certain features including wearing an indicia of dating status, such as jewelry or any other easily visible wearables, like ribbons, headbands, hats or the like.

A second aspect of the present invention includes the use of a website contact system for enabling the second chance connection that is the ultimate goal of the present invention. A proactive participant may be viewed publicly by another active participant, and they then can go to the message board on the website and put in the zip code where they saw the person with the indicia on and they are able to post messages online which if the person agreeable, then they can make the second chance connection.

Although the invention will be described by way of examples herein below for specific aspects having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different aspects and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various aspects of the present invention, reference shall be made to the following detailed description, and when taken in conjunction with the accompanying drawings, in which like parts are given the reference numerals, and wherein;

FIG. 1 is a view of a dating status bracelet made in accordance with the present invention;

FIG. 2 details the bracelet of FIG. 1;

FIG. 3. is a view of another aspect of the present invention embodied in a ring;

FIG. 4 shows other wearables, including earrings and/or a necklace; and

FIG. 5 is a flowchart diagrammatically explaining one aspect of the methods of making contact with a proactive approach;

FIG. 6 is a flowchart diagrammatically explaining another aspect of the methods of making contact with a reactive approach; and

FIG. 7 provides the method steps in a flowchart format for yet another aspect of a method to be practiced with the present invention.

### DETAILED DESCRIPTION OF THE INVENTION

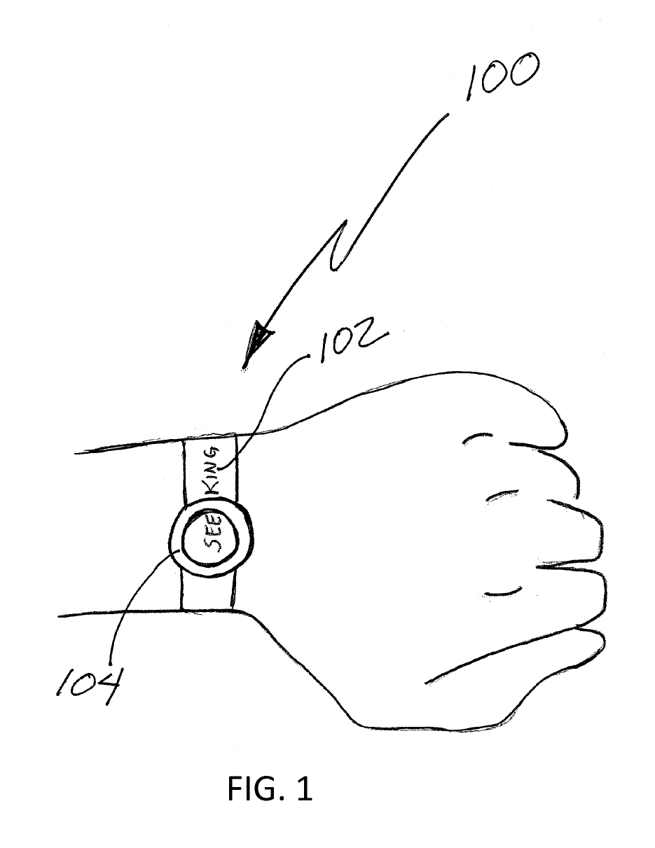

Referring now to the drawings in detail, FIG. 1 is a bracelet generally indicated by the numeral 100, which also includes a band 102 with a message ring 104. This is one aspect of the wearable indicia of SEEKING status that could be worn in public to attract the eye of potential suitors.

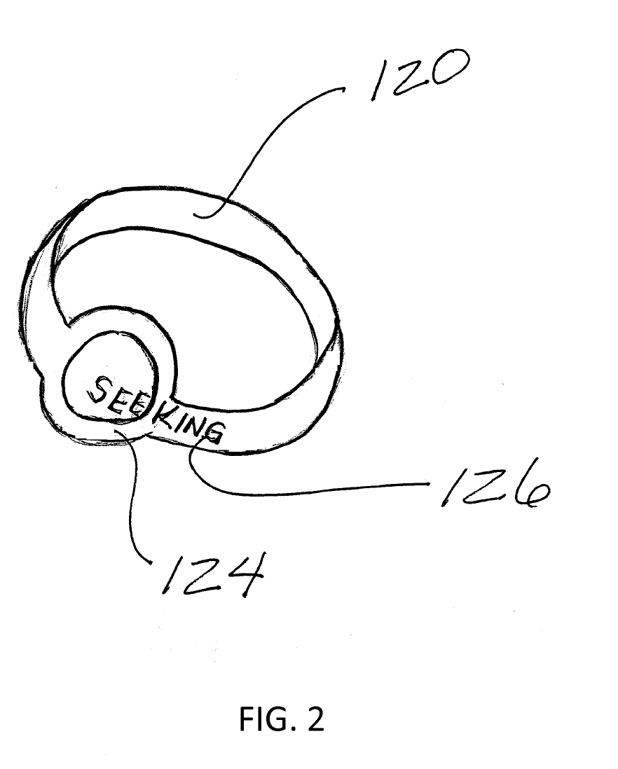

FIG. 2 is a perspective view of the SEEKING bracelet or ring made in accordance with the present invention. The ring 120 includes a trademark circle 124 and the logo “SEEKING” 126. When viewed by third parties, the “SEEKING” indicia will indicate to the viewer that the wearer of the “SEEKING” article can be messaged on a website that accepts messages from viewers. Such a message can be returned to begin a reciprocal relationship, and then personal information can be traded as soon as both parties are comfortable with each other.

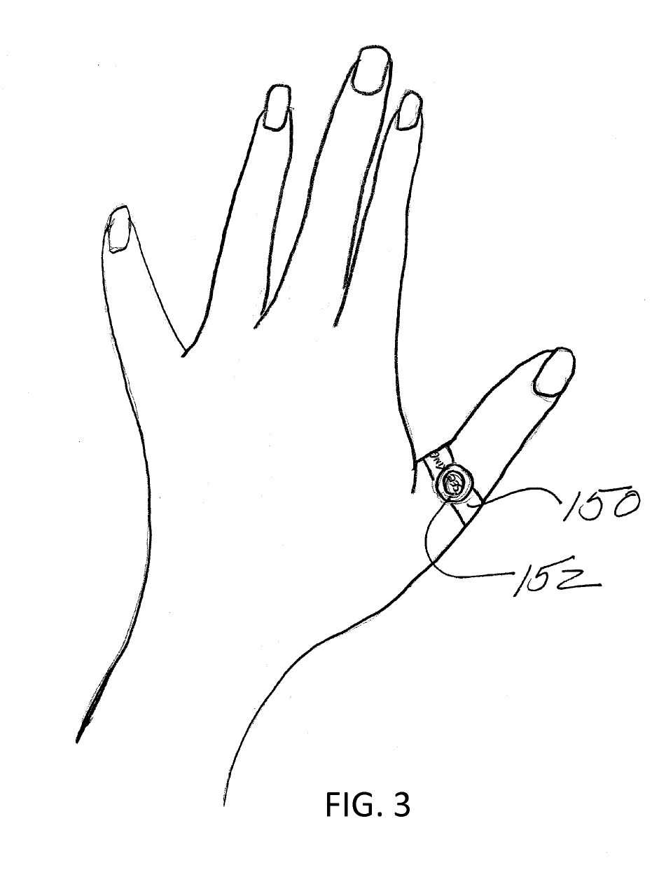

Looking next to FIG. 3, there is shown another aspect of the present invention, i.e. a ring 150 with the SEEKING indicia 152. The ring 150 is plainly visible such that if someone sees you in public and they want to get to know you, if they recognize the SEEKING indicia, they can go home, look up the website for SEEKING, enter the zip code in which they saw you, and place a message on an online message board on the SEEKING website. If you are interested in meeting that person that you saw wearing the SEEKING logo, you can put your message on the message board and then you'll be able to make the connection, all without posting your private information or a personal profile on the website in order to attract attention.

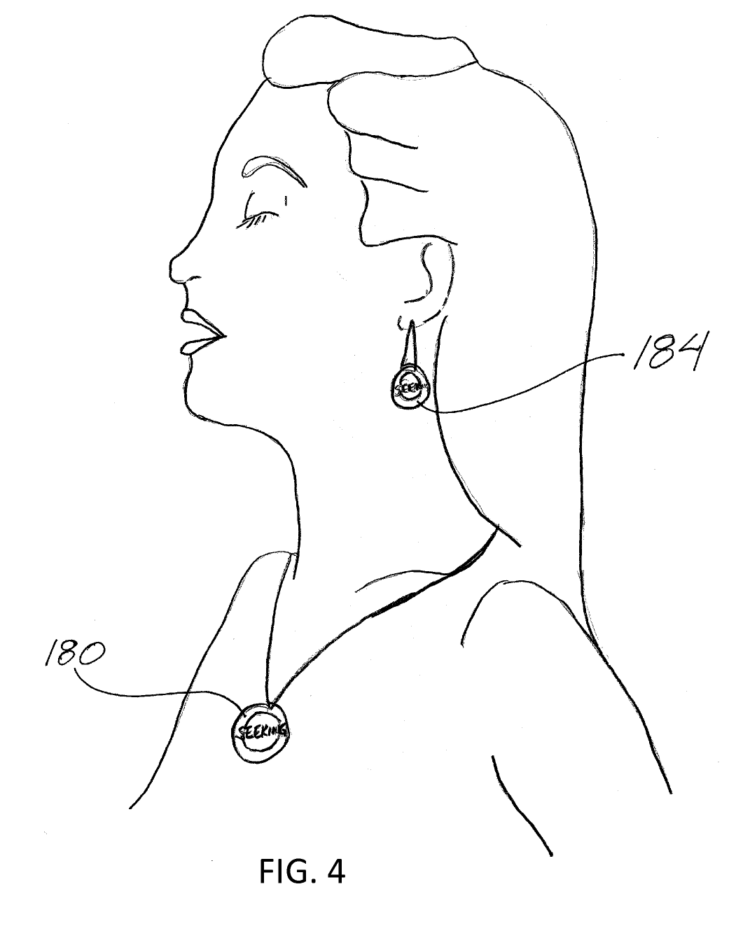

FIG. 4 shows yet more aspects of the present invention including a necklace or earrings. Not only does the present invention embody such wearables, but the concept of the present invention includes any other visible form of any type of wearable that is visually displaying the fact that you are a SEEKING member. Such other wearables may include hats, ribbons, headbands, t-shirts, or the like. Any suitable form of indicia containing wearable is within the scope of this invention, and any lack of description of a particular type of wearable does not negate the effect of this invention.

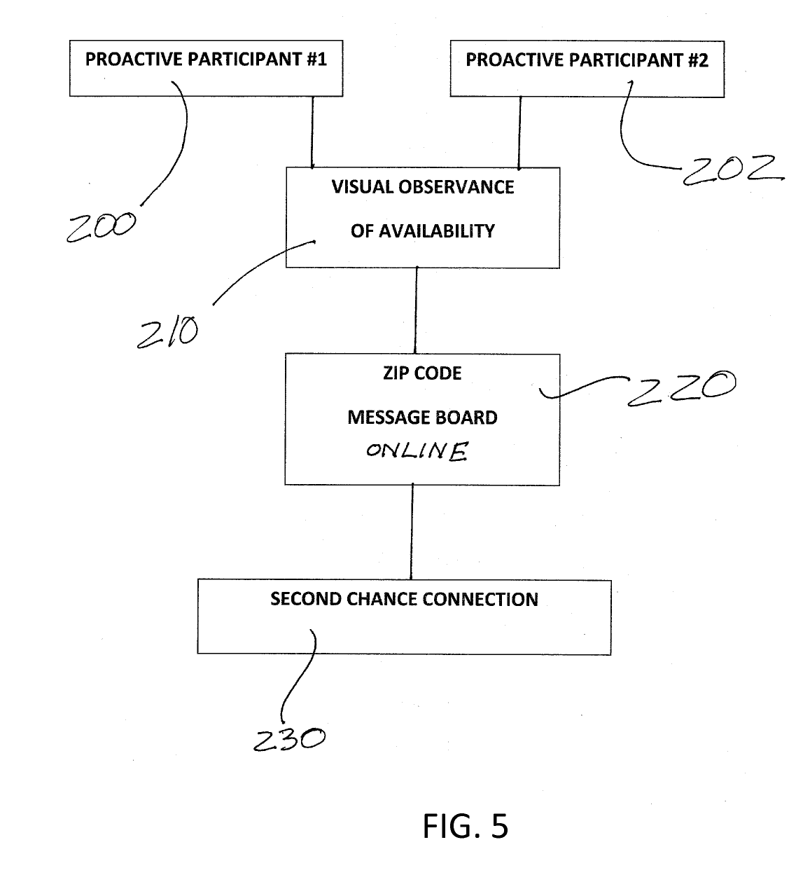

FIG. 5 illustrates an active connecting flow chart for the method to be utilized in accordance with the present invention. In FIG. 5, proactive participant No. 1 is denoted by numeral 200 while proactive participant No. 2 is denoted by numeral 202. In optimal situations, both participants would have visually observed one another and will notice that each is an available or single participant because they are wearing SEEKING indicia. Then, in accordance with this invention, both participants would go to the message board on the seeking website and see if there were messages posted for each other. In this aspect, it is considered “proactive” because both of the participants knew that there was some interest, and that they should go to the SEEKING website message board.

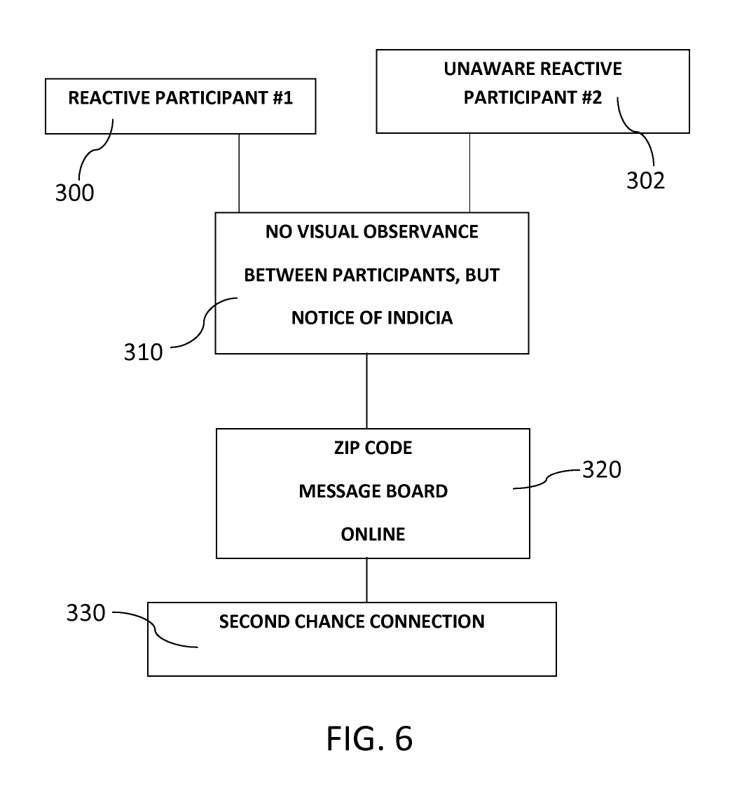

Looking next to FIG. 6, with regard to further aspects of my invention, this is a description of a situation called a “reactive” aspect, where one of the parties 300 knows that there is some interest, while the other person 302 is totally unaware. Since there is no visual observance 310 between participants 300 and 302 respectively, this is a “reactive” situation that could eventually lead to a second chance connection 330. Because that person is unaware, they would have to go to the message board 320 on a regular basis in order to seek out potential messages, unless of course, a notification system of one sort or another is implemented. As described more fully hereinbelow, there may be a possibility of notifications to the unaware person, such as a text or data message left for them on their phone, or a buzzing on their bracelet, or any other suitable notification means. As the participant is unaware, they may not have any idea what the person who left the message looks like, or if they would have any interest depending upon other factors. In this instance, the message would have to request for a second chance meeting, possibly transferring the unaware person to someone there is a profile, like Match.com, or any other likely website In order to generate more interest.

For example, if a woman is jogging through a park and wearing one or more of the SEEKING indicia, and a fellow runner is a man interested in meeting the woman, and he notices that she is wearing a SEEKING indicia wearable, then he can go and enter their zip code on the SEEKING website in which he saw her and leave her a message on the message board. If he waves at her or makes some other noticeable recognition, then she may be interested in meeting him and would know to go and look at the SEEKING website and then respond to his message on the message board. Thereafter, if she likes the message, she can set up a phone call, and if she likes him, they can communicate further. This provides the “second chance connection”.

The “second chance connection” occurs when the first chance fails to get each other's contact information. In other words, if she is jogging through the park and he notices her and waves at her and he wants to continue running without making an initial contact at that moment, then a second change connection is made possible through the use of the present invention. Since he would have tipped his hat or waved at her, she may know that she might like to go look on the message board to see if he left a message. She can then respond and then they can plan when they be able to meet again for perhaps a cup of coffee or a dessert. Hence the “second chance connection”.

Another example may be an instance where an auto mechanic is working at an auto repair shop while wearing the SEEKING bracelet. He fixes a woman's car and they talked easily through it. He thought there might be some kind of connection, but was too uncomfortable in his commercial workplace setting to try to make the connection. He can then post an ad on the SEEKING website because he was wearing his bracelet, and thought she might notice. He might be thinking I have my bracelet, and if she is interested, she will know to go check the website. She may go home thinking about him and knows that he has a SEEKING bracelet on, so she goes to check the website and replies or, in the alternative, she can also leave him an ad on the SEEKING website. In a final alternative, a person may not need a bracelet to check the website or post an ad. They might just want to try it. However, it would be more advantageous if a participant was wearing some sort of SEEKING indicia, though, because if they are wearing one, you will know that there is a common ground, and you would know where to go.

Likewise, if a man was not interested in a woman that was showing interest in him because of his SEEKING wearables, he would simply not respond to her message on the message board, and would not have an embarrassing situation of having to reject the woman which would happen under other prior art methods of dating and “connecting”.

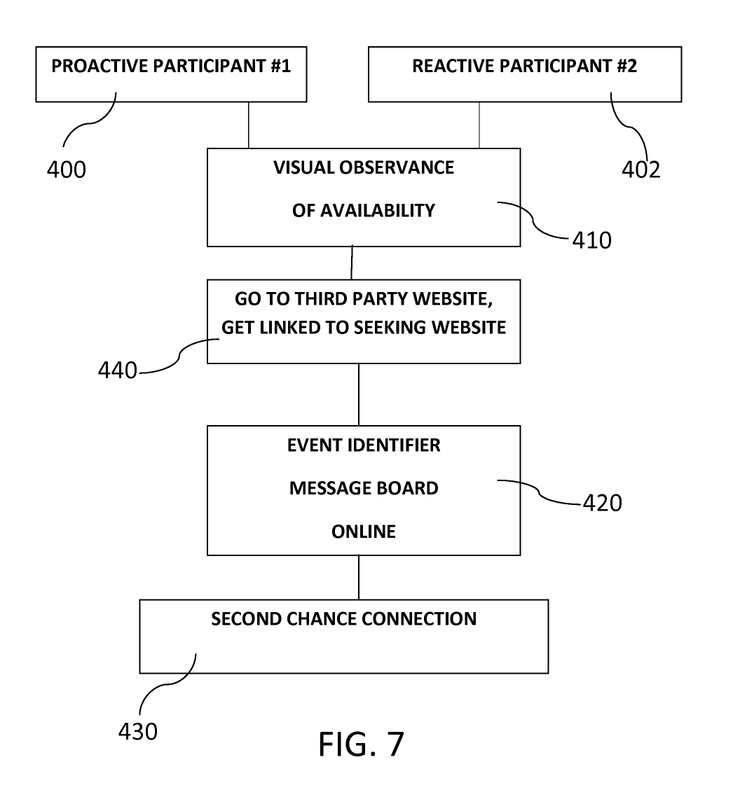

FIG. 7 describes yet another method of the present invention wherein there is a proactive participant 400 that sees a reactive participant 402 in the public. This participant 400 may be directed to a public website, such as a website at a NASCAR event, wherein there may be a SEEKING icon on the NASCAR website 440. If you would like to make contact with someone 402 that you saw was wearing a SEEKING indicia, you would go on the NASCAR website, click on our icon, and be able to leave a message on our SEEKING website 420 for “the girl in the pink jacket section 101”. In this aspect, the message will go to one website that does not include any profile or anything and it will direct you to the SEEKING website 420. In the event that a participant wishes to have a profile, whether short or long, that would be up to the participant. This activity could lead up to a second chance connection 430.

In yet another aspect of the invention, a participant could go on to the SEEKING website and then been redirected to a another website, such as Match.com, where they can view a profile. In terms of linking the SEEKING website to other websites or other event type websites, the possibilities are nearly endless. This concept is primed to include leading back to any website that maybe desire for wearing business relationship has become established.

Let us return to the example of the NASCAR event. In order to participate, the single girl that we discussed hereinabove wearing the pink jacket in section 101 would be wearing a SEEKING hat or vest, or one of the other SEEKING indicia products. A young man who might see her in the crowd would also be a SEEKING participant and he would be able to go to the main NASCAR website on his smart phone and leave a message after he had clicked on the SEEKING icon on the face of the NASCAR website. In yet another aspect of the present invention there could be an automatic notification to all those who are SEEKING participants, such as a buzz on your phone, a bracelet that buzzes, a bell tone on your smart phone, or any other method of providing automatic notification. Once the SEEKING participants had received this notification, they would all go to the SEEKING website to see if they were the one.

This automatic notification concept could also be extended to include embedded electronic tracking devices so that your location could be shown if you so desire, or an add-on piece to something such as a Fitbit type of bracelet that one would wear when you're out jogging. Furthermore, there could be electronically linking of the SEEKING website to a participant's own website if they had one. All of these aspects are mere variations on the main theme of getting a second chance meeting to take place without divulging sensitive personal information before both parties can show an interest.

Further disclosed here is a franchising model and method of doing business. This business model is also then hereby disclosed for utilizing a dating method without necessarily having to place an upfront profile or posting of your personal information on a website. For people that do not want their personal information posted on websites for the whole world to see, this is an important innovation. Single people can meet, and have the option of whether or not to respond to the person that showed interest. For example, let's go back to the woman running in the park and the gentleman waving at her. In the event that she notices him waving at her, but she is not interested, then she would merely not respond to his message on the message board and he would not have any of her personal information. This would be most satisfactory for a woman in this situation.

There are many variations of this particular business model, and the franchising of such a connecting website could easily be accomplished in any number of cities in the country. Licenses could be made for the wearables, and a complete franchising package could include the supply of various dating indicia that would be universally recognized nationwide. Many of the various franchises could pool their advertising money to provide a national advertising campaign to get further recognition. As one can imagine, there are many commercials on television for eHarmony, or Match.com or Christian Mingles.com and the SEEKING method of allowing people to connect in a very private, dignified and classy manner would be possible. As one can imagine, any name can be used, but we are using the name “SEEKING” for the purposes of this patent application, and the scope of my invention shall not be limited to the use of any particular name, rather any suitable name may be used in the practice of my invention.

In summary, numerous benefits have been described which result from employing any or all of the concepts and the features of the various specific aspects of the present invention, or those that are within the scope of the invention. The dating status indicia and method of making contact acts perfectly to provide a method of making contact with a stranger that you find attractive, but needed a second chance to make the connection, all without jeopardizing one's privacy.

The foregoing description of a preferred aspect of the invention has been presented for purposes of illustration and description. It is not intended to be exhaustive or to limit the invention to the precise form disclosed. Obvious modifications or variations are possible in light of the above teachings with regards to the specific embodiments. The aspects have been chosen and described in order to best illustrate the principles of the invention and its practical applications to thereby enable one of ordinary skill in the art to best utilize the invention in various aspects and with various modifications as are suited to the particular use contemplated. It is intended that the scope of the invention be defined by the claims which are appended hereto.

What is claimed is:

1. A device for indicating single status for potential suitors, comprising:
a wearable device including an indicia of interest in dating other single people,
wherein the indicia is tied to a message center or board of any sort, but especially a website designed to be accessed by members looking for messages specific to them;

2. The device of claim 1,
wherein said message center or board is selected from the group consisting of a dedicated website, a message board, Facebook, a third party website with a link to the message center, or combinations thereof, and the members are hoping to make a second chance connection;

3. A method of making a second chance connection with another single person, comprising:
both participants in the program being members of a singles group wearing a wearable indicia;
noticing the participant wearing the indicia and wanting to make contact at a later date, for a second chance connection;
going to the program's website or any other designated messaging center or board and leaving a message that is directed toward the participant that was observed and desired.

4. A method of doing business to help singles engage in second chance connections, comprising:
establishing a website or other message place to receive messages;
distributing wearable indicia to participants;
receiving messages and displaying them on the message choice of the participant; and
receiving a monthly fee for participation in the program.
